(19) United States
(12) Patent Application Publication
(10) Pub. No.: US 2013/0317848 A1
(43) Pub. Date: Nov. 28, 2013

(54) Electronic Medical Record Process

(71) Applicant: Andrew Savin, Buffalo Grove, IL (US)

(72) Inventor: Andrew Savin, Buffalo Grove, IL (US)

(21) Appl. No.: 13/477,262

(22) Filed: May 22, 2012

(51) Int. Cl. G06Q 50/24

(52) U.S. Cl. 705/3

(57) ABSTRACT

A user friendly improved process can include: transmitting and detecting a user identification (ID) signal providing an electronic code of a physician or other medical personnel; electronically comparing the user ID signal with an electronic database of authorized users to determine if the physician or other medical personnel is an authorized user; and authorizing access to each electronic medical record (EMR) of patients of the authorized user. After access is allowed, the authorized user can input patient information, prescriptions and physician's notes into the EMR, generate the user's signature on the EMR as well as view, transmit and print the signed prescription or EMR.

### BACKGROUND OF THE INVENTION

This invention relates to medical records, and more particularly, to a process for accessing, creating and modifying electronic medical records.

In the past, every prescription or progress note was hand signed by the user on a printed electronic medical record (EMR) after the physician typed a unique password into a blank password field of a computer. This was repeated voluminous times a day. Most EMR systems are not allowed to electronically prescribe medications, such as opiate pain medication and sedatives, due to the lack of security with single factor identification. Conventional EMR systems cause numerous problems, such as:
1. Repetitive typing of the user's password wasting valuable time for the clinician, taking away time with patients.
2. Lack of a second form of authentication, which limits the type of medications which could be prescribed electronically.
3. Risk of errors in typing passwords.
4. Time consuming other forms of authentication, such as swiping a card, fingerprint scan, retinal scan, requiring as much if not more time than typing in the password manually.
5. There is a great risk of fraud and abuse of prescriptions, whether written or phoned in by staff, with the conventional lack of authentication of the prescriber.
6. Time and expense of having staff or providers call in and fax many types of medications is significant, considering how many prescriptions are sent each day.
7. Frustrating delay for patients filling medications prescribed after a visit to an emergency room, hospital or acute care center. Many of those medications are for pain, and those cannot be currently being sent to the pharmacy electronically due to lack of two factor authentication required by the U.S. Drug Enforcement Administration (DEA) (Department of Justice), resulting in patients waiting for medications at the pharmacy. Furthermore, many patients must often bring their prescriptions in person or manually to the pharmacy.

Over the years various systems and processes have been developed or suggested for accessing, creating and modifying EMRs. These conventional systems and processes have met with varying degrees of success but are often expensive, burdensome, cumbersome, inefficient and ineffective.

It is, therefore, desirable to provide an improved EMR process, which overcomes most, if not all of the preceding problems and disadvantages.

### BRIEF SUMMARY OF THE INVENTION

An improved electronic medical record (EMR) process is provided for easily, safely and securely accessing, creating and modifying EMRs. Advantageously, the user friendly process can generate, transmit and print electronically signed prescriptions, medical notes (progress reports) and other EMRs. Desirably, the efficient process is convenient, economical and effective. The reliable process also complies with the two factor authentication required by the U.S. Drug Enforcement Administration (DEA) of the U.S. Department of Justice.

The goal of this special EMR process is to make the electronic signing of EMRs, prescriptions and documents safer, quicker and easier than what is available now. The EMR process and system can improve user security when signing documents and prescribing medications. It can involve adapting current RF technology to a process currently not available.

This improved EMR process and system can involve four basic components: (1) a radio frequency (RF) emitting powered card or other radio frequency identification (RFID) communications device, (2) a central processing unit (CPU) such as at a computer workstation (WS), (3) an RF receiver or other RFID signal-detector connected to the CPU or workstation, and (4) a unique password associated with the RF card and user.

The process for using the EMR process and system can be as follows. The user, such as a physician, can have unique RF card on their person. This can be on their lab coat for example. If the user is within a specified distance from the RF receiver or other RF signal-detector on the WS, the CPU on workstation would identify that that user's card is present. To confirm that the actual user is present, and not just the RF device itself, the user should sign into CPU at the work station with their password. If the user leaves after signing their password, and they come back before the grace period has elapsed, the user is still signed in. As the user is working on their workstation, since the RF card is present and the password has been authorized, the CPU knows that the person at that work station is authentic. The process and system secures the WS computer when the user leaves and unlocks it when they return to the WS, eliminating the need to sign on again.

Advantageously, the RFID EMR process and system can be uniquely configured to securely place the users' password automatically once a physician's note or prescription needs to be signed. Whereas the password field currently requires a manually typed user password, the user friendly improved RFID EMR process and system would authorize the prescription immediately without the user seeing the blank password field at all. The moment the note or prescription is approved by the provider, the vendor can receive an electronic request for approving the document. The software assures the user is authentic by comparing the password placed within the predetermined grace period on the WS computer or other CPU to the RF device that is present at the WS at the time the document is accepted. The software will then take over and clear the prescription as “signed” automatically; no empty password field will appear, the prescription is sent immediately, or the electronic progress record or physician's note is closed. If the user is not at WS computer after the grace period ends, the user will need to put their unique password once more in that WS computer or other CPU and the cycle will start again if the physician is still wearing their RF badge.

The user friendly improved process can include: transmitting a user identification (ID) signal corresponding to a physician or other medical personnel; detecting the user ID signal; electronically comparing the user ID signal with an electronic code or other indicia of authorized users to determine if the physician or other medical personnel is an authorized user; and authorizing access to each electronic medical record (EMR) of patients of the authorized user. After access is allowed, the physician or other authorized medical personal can input information into the EMR, generate a new EMR, view the EMR, generate their electronic signature on the EMR, transmit the electronically signed EMR to a designation selected by the authorized user, and print electronically signed EMR.

Significantly, after access is allowed, the physician or other authorized medical personal can: input an electronic prescription into the EMR, generate an electronic signature authorized by the authorized user onto the electronic prescription, and transmit the signed electronic prescription to a designated location such as pharmaceutical department of a hospital, the check out desk of the medical facility of the authorized medical personal, the patient's pharmacy or drug store, and/or print the electronically signed prescription.

Desirably, after access is allowed, the physician or other authorized medical personal can: input physician's notes about the patient into the EMR, generate an electronic signature authorized by the authorized user onto the electronic physician's notes, and transmit the signed physician's notes to a designated location such as to a database, electronic storage facility, and/or print the physician's notes.

In the preferred form: the user ID signal is a radio frequency (RF) signal, the user ID signal is transmitted from a user RFID communications device, the user ID signal is detected by a RF reader or other RFID signal detector, the electronic comparing occurs in a central processing unit (CPU), the EMR is accessible in the CPU, and the EMR is viewable on a display of the CPU.

A more detailed explanation of the invention is provided in the following detailed descriptions and appended claims taken in conjunction with the accompanying drawings.

### BRIEF DESCRIPTION OF THE DRAWINGS

FIG. 1 is a perspective view of a physician wearing RFID communications devices comprising a RFID badge and RFID card clipped to their medical gown or lab coat in accordance with principles of the present invention.

FIG. 2 is an enlarged perspective view of a RF signal-detector and another RFID card with a clip in accordance with principles of the present invention.

FIG. 3 is an enlarged perspective view of a further RFID card and another RF signal-detector comprising a RFID USB reader that plugs into a slot or port in the CPU in accordance with principles of the present invention.

FIG. 4 is a perspective view of another RFID card and a further RF signal-detector comprising a RFID USB card reader that can connect to a cable that plugs into a slot or port in the CPU in accordance with principles of the present invention.

FIG. 5 is a reduced perspective view of a handheld RFID card reader and writer in accordance with principles of the present invention.

FIG. 6 is a reduced top plan view of a RFID module for placement in the interior of the CPU in accordance with principles of the present invention.

FIG. 7 is a perspective view of another physician with a CPU, display and inputting devices, comprising a wireless mouse, keyboard, and headset with a microphone that operates with voice recognition software in the CPU in accordance with principles of the present invention.

FIG. 8 is a perspective view of a further physician with a CPU comprising a a cellular (cell) phone with a touchscreen display and electronic stylist for writing an electronic signature in accordance with principles of the present invention.

FIG. 9 is a perspective view of electronic pen for writing an electronic signature on the touchscreen display of a tablet computer or ipad in accordance with principles of the present invention.

FIG. 10 is a perspective view of another electronic writing instrument for writing an electronic signature on the touchscreen display of an electronic signature writing device and a cable for connecting the electronic signature writing device to a slot or port of the CPU in accordance with principles of the present invention.

FIG. 11 is a reduced top perspective view of a printer for printing an electronically signed prescription in accordance with principles of the present invention.

FIG. 12 is a perspective view of a combination printer and scanner for printing electronically signed physician notes as well as for scanning signatures in accordance with principles of the present invention.

### DETAILED DESCRIPTION OF THE INVENTION

The following is a detailed description and explanation of the preferred embodiments of the invention and best modes for practicing the invention.

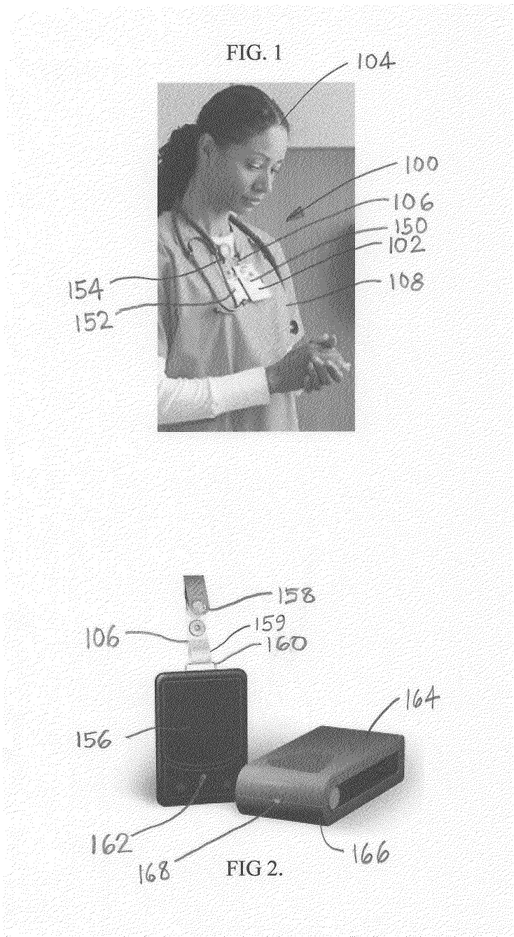

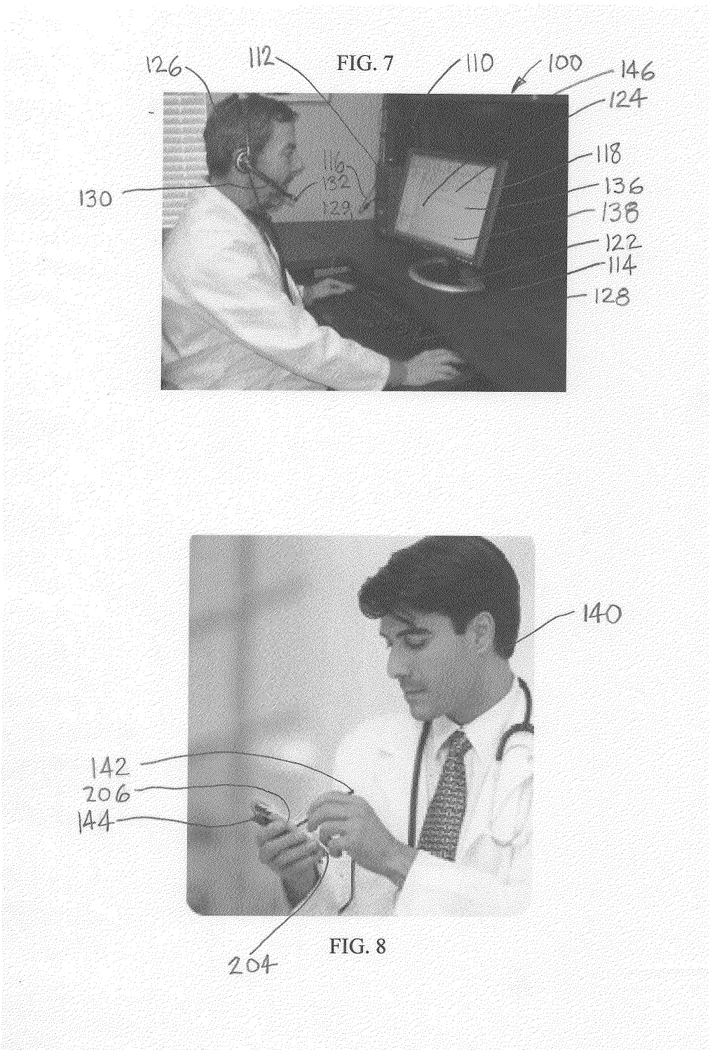

In the preferred radio frequency user identification (RFID) and electronic medical record (EMR) process and system 100 (FIG. 1), a RFID communications device 102 can be provided to and worn or carried by an authorized physician 104 or other authorized medical personnel, such as clipped by a RFID carrier 106 to their laboratory (lab) coat 108 or medical gown. The RFID communications device can transmit a RFID signal which can be sensed and detected by a radio frequency (RF) signal-detector 110 (FIG. 7) that is operatively connected to a central processing unit (CPU) 112 at a workstation (WS) 114, such as by hard wiring 116 or wireless communications (wireless connection). The CPU can be hard wired by a bundle of wires or cable and/or or in wireless communication, such as by bluetooth, via an antenna with one or more related equipment and components, e.g. a display 118, printer 120 (FIG. 12), and optionally one or more interactive communications devices. If desired, the display can be mounted on a stand 122 (FIG. 7) which can be separate from and/or operatively associated with the CPU.

In the preferred process, at least one electronic medical record (EMR) 124 (FIG. 7) is electronically stored in the CPU and the CPU and/or RF signal-detector can determine if the authorized physician 126 or other authorized medical personal is authorized and approve to access the EMR in the CPU by electronically comparing the user ID signal with indicia of an authorized user in the CPU and/or RF signal-detector. The CPU will authorize access to each EMR of patients of the authorized physician or other authorized medical personal in the CPU if the authorized physician or other authorized medical personnel is an authorized user Such authorization allows the authorized user to access and retrieve the EMR in the CPU, view the EMR on the display that is operatively connected to the CPU, and input information into the EMR with an inputting device 128-130 that is hard wired or coupled by a wireless connection to the CPU.

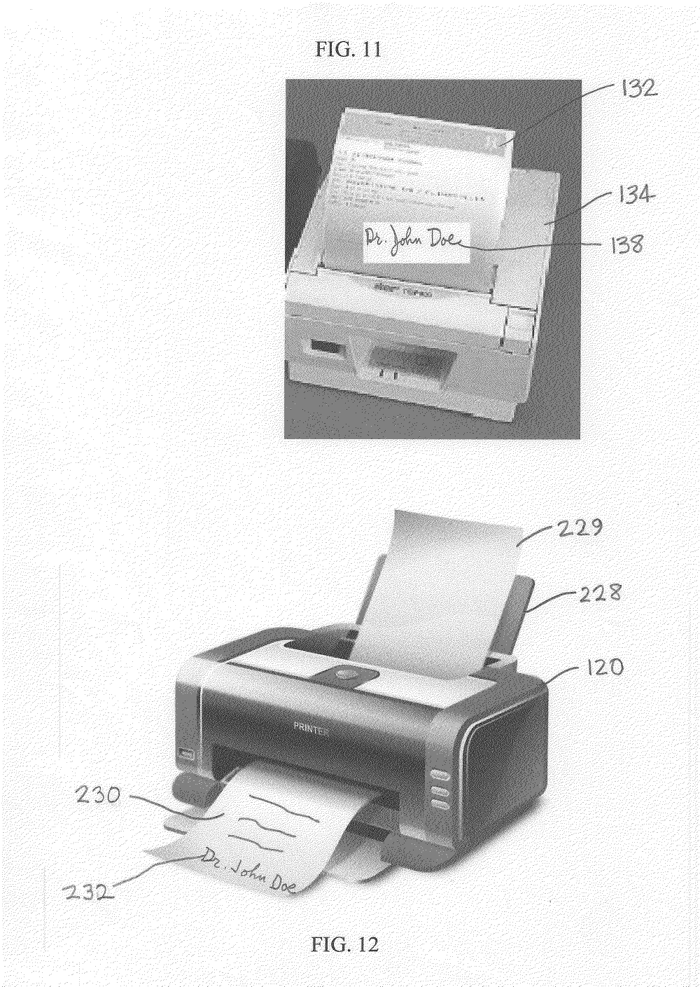

In one preferred process, the CPU determines if the physician or medical personnel is authorized to access to write and print a prescription 132 (FIG. 11) from a prescription printer 134, such as in a location where the prescription is being electronically written or filled, by electronically comparing the user ID signal with a CPU accessible electronic file, electronic list or data base of persons authorized to write prescriptions at the location. If the CPU authorizes access to write prescriptions, an electronic prescription 136 (FIG. 7) for medication of at least one of the patients of the authorized user (authorized physician or other authorized medical personnel) can be inputted and electronically written and inputted with the inputting device into the EMR in the CPU.

Desirably, the electronic signature 138 (FIG. 11) of the authorized user 140 (FIG. 8) can be electronically written, transmitted to and stored in the CPU with an electronic signature writer 142 (FIG. 8), such as a electronic stylus 144, electronic pen, electronic writing instrument, ipad, electronic tablet device, cellular phone with a touchscreen display, other electronic communications device, or combination of any of the preceding. The signature of the authorized user can also be written on paper, scanned on a scanner, such as with a combination scanner/printer device 120 (FIG. 12), and transmitted to the CPU. The CPU can then generate the electronic signature of the authorized user on the electronic prescription. The signed electronic prescription can be transmitted by the authorized user from the CPU to a pharmaceutical location designated by the authorized user, such as pharmaceutical department of hospital, the checkout desk of the medical facility of the authorized medical personal, the patient's pharmacy or drug store, and/or can be printed on the printer.

In another preferred process, the authorized user can electronically write and input a progress report, physician's notes or other notes into the CPU to create electronic medical notes 146 (FIG. 7) by electronically inputting information about at least one of the patients of the physician or other authorized medical personnel into the EMR in the CPU with the inputting device. The CPU can then generate the electronic signature of the authorized user on the electronic medical notes in the CPU. The signed electronic medical notes can be transmitted by the authorized user from the CPU to a location designated by the authorized user, such as to a data base on the network or at a remote location, and/or can be printed on the printer.

Preferably in the process, access to the EMR in the CPU is denied and inaccessible after a preselected period of time (grace period) when no RFID signal from the RFID communications device is sensed and detected by the RF signal-detector. Also, the CPU can be locked and inaccessible until the user logs in by inputting an authorized user password into the CPU with the inputting device.

In use, the user can approach the workstation (WS) computer or other CPU wearing the RFID communications device. The RFID signal-detector installed in or otherwise operatively connected by hard wires or wireless communication to the CPU can identify the user by the RFID signal providing a RF code transmitted by the RFID communications device to the receiver or other RFID signal-detector installed. The user can access the CPU once the RFID signal-detector electronically determines that the user is authorized to access the EMR in the CPU. The user can input or type a unique password once in the password field of the CPU to unlock the CPU. The CPU now allows the user to access, update and modify the EMR. The user through the inputting device and CPU can set up prescriptions, finish a progress note, and sign the electronic document. A transceiver or CPU can send and transmit a signal that the user has created a document that requires a signature. Then the CPU or a clearing house (RF vendor) can confirm that both RFID signal and password are correct and thereafter an approval signal can be received or generated by the CPU, such as via a EMR server, that the user is authorized to approve and sign the prescription or medical note and subsequently the CPU will electronically and automatically complete and sign the electronic prescription and electronic medical note. The prescription can then be electronically sent and transmitted to the pharmacy and the electronic medical note can be transmitted and/or printed. The user does not need to fill in or even see the password field again, as it can do invisibly, automatically and electronically. The user can continue to repeat this process without logging in or inputting their password in the EMR again as long as they are at that WS or other CPU and have not left the RF receiver range of the RF signal-detector longer the grace period allows. Once the user leaves the WS or other CPU and has not returned before the grace period ends, the RFID CPU system resets and the CPU is locked and inaccessible.

As shown in FIG. 1, the physician can wear RFID communications devices comprising a RFID badge 150 and/or RFID smart card 152 attached by an RFID carrier comprising clips 154 to their medical gown or lab coat 108.

FIG. 2 illustrates another RFID card 156 with an with a RFID carrier 106 comprising a snap clip (button snap) 158 on a plastic or fabric band 159 connected to a ring or bracket 160 which can be attached to the RFID card. The RFID card can have an emitter or transmitter 162 for transmitting a RFID signal. FIG. 2 also illustrates an enlarged perspective view of a RF signal-detector 164 comprising a wireless RFID reader 166 that can be connected by wireless communications or hard wired by cables to the CPU. The RFID reader can have a sensor 168 for sensing and detecting the RFID signal emitted from the RFID card.

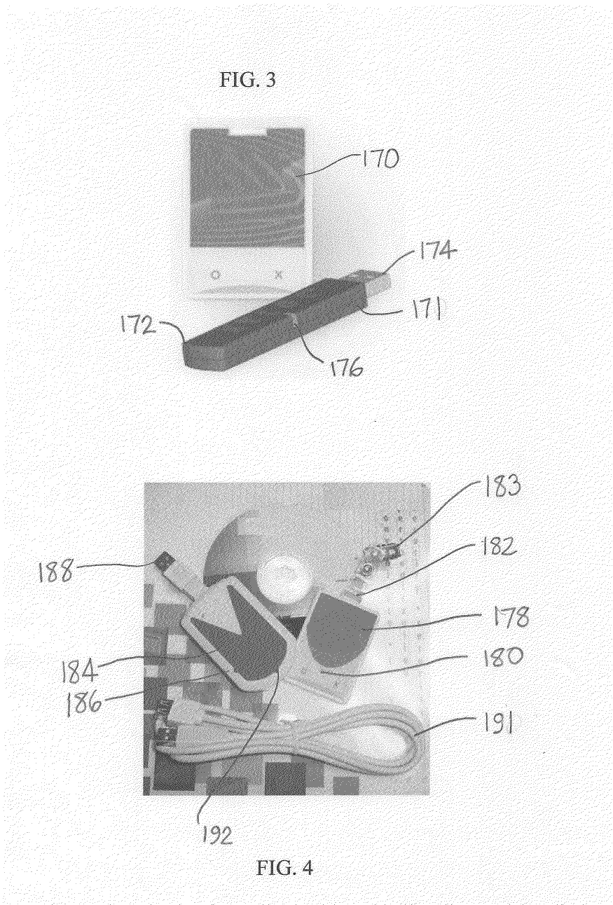

FIG. 3 illustrates a further RFID communications device and RFID card comprising a RF emitting powered card 170. FIG. 3 also illustrates another RF signal-detector 171 comprising a RFID universal serial bus (USB) reader 172 with a USB plug 174 that plugs into a slot or USB port in the CPU. The RFID USB reader can have a sensor 176 for sensing and detecting the RFID signal emitted from the RF emitting powered card.

FIG. 4 illustrates another RFID communications device and RFID card comprising a RF-enabled contactless smart card 178 with an emitter or transmitter 180 for transmitting a RFID signal. The RF-enabled contactless smart card can be held by a RFID carrier 182 with a clip 183 that can be detachably fastened to a lab coat or other clothing of the physician or medical personnel. FIG. 4 also illustrates a further RF signal-detector 184 comprising a RFID USB card reader 186 with a USB plug 188 that plugs into a slot or USB port in the CPU in accordance, or can do so via an extension cable 190 with USB plugs. The RFID USB reader can have a sensor 191 for sensing and detecting the RFID signal emitted from the RF-enabled contactless smart card.

FIG. 5 illustrates a RF signal-detector 192 comprising a handheld RFID card reader and writer 194 with a handle 196 providing a handgrip. The handheld RFID card reader and writer 194 can have can have a sensor 198 for sensing and detecting the RFID signal emitted from the RFID communications device.

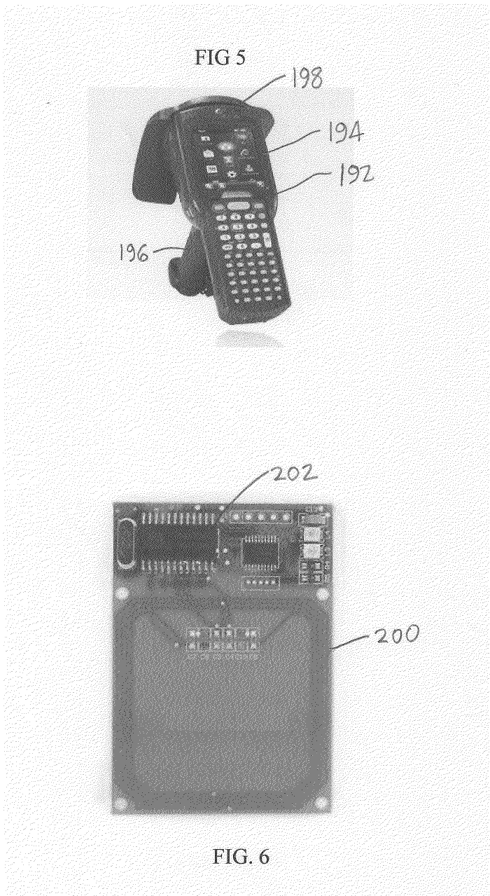

FIG. 6 illustrates a RF signal-detector 200 comprising a RFID module 202 providing a RFID reader and writer and printed circuit board (PCB) that can be secured in the interior of the CPU and placed in proximity to the motherboard.

FIG. 7 illustrates another physician 126 with a CPU 112, display 118 and inputting devices, comprising a wireless keyboard 128, wireless electronic mouse 129, and wired or wireless headset 130 with microphone 132 that operates with voice recognition software in the CPU.

FIG. 8 illustrates a further physician 140 with a CPU and electronic signature writing device 142 which can comprise a cellular (cell) tablet phone 204 with a touchscreen display 206 and electronic stylist 142 for writing an electronic signature.

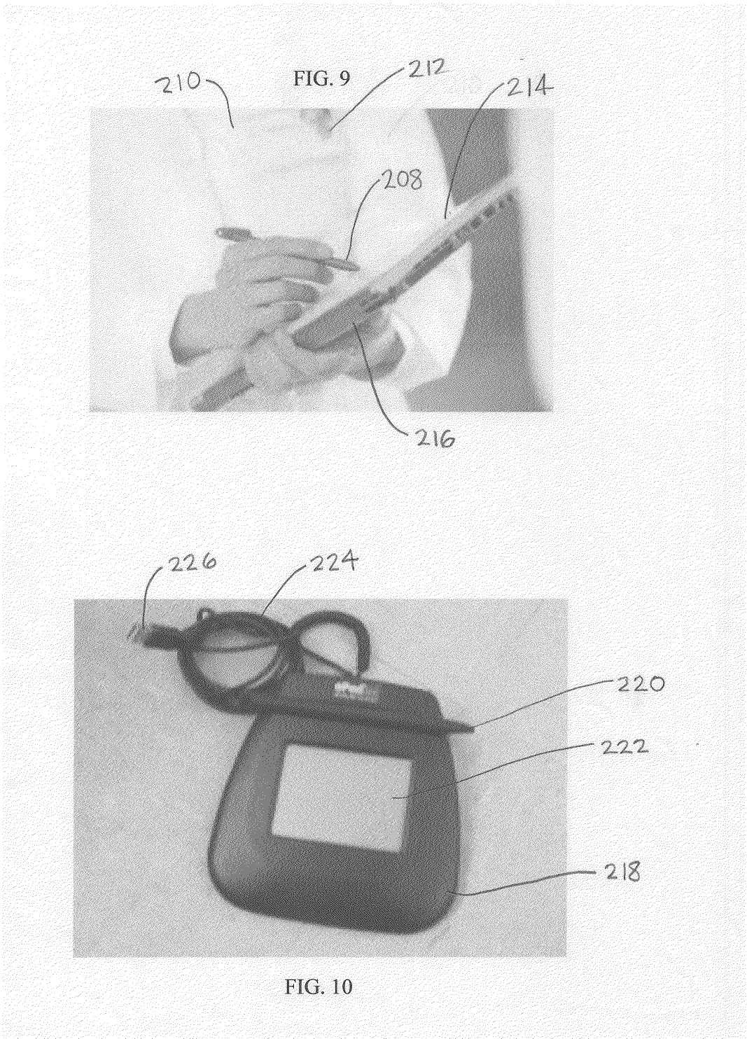

FIG. 9 illustrates an electronic pen 208 for use by a physician or medical personnel 210 with a RFID badge 212 to write an electronic signature on the touchscreen display 214 of a tablet computer 216 or ipad.

FIG. 10 illustrates another electronic signature writing device 218 with an electronic writing instrument 220 for writing an electronic signature on the touchscreen display 222 of the electronic signature writing device and a cable 224 with a USB plug 226 for connecting the electronic signature writing device to a slot or USB port of the CPU.

FIG. 11 illustrates a wireless printer 134 providing a prescription printer that can be connected by wireless communications or cable to the CPU for printing an electronically signed prescription 132.

FIG. 12 illustrates a combination printer and scanner 120 that can be connected by wireless communications or cable to the CPU. The combination printer and scanner can have a feeder 228 with paper 229 for printing electronically signed physician notes 230 with the printed electronic signature 232 of the physician, as well as for scanning signatures of the physician and other authorized medical personnel.

The RFID communications device can comprise: a RFID card, RF emitting powered card, RFID tag, RFID badge, RFID label, RFID transducer, RFID chip, RFID microchip, active RFID communications device, passive RFID communications device, and battery assisted passive RFID communications device, implanted RFID communications device, RF-enabled smart card, RF-enabled contactless smart card, or combinations of any of the preceding.

The RFID communications device can be carried by a RFID carrier, such as: a RFID card protector, clip, wallet, purse, envelope, sleeve, pocket, wrist band, bracelet, neck band, necklace, ankle band, ankle bracelet, belt, medical gown, laboratory (lab) coat, portable electronic communications device, pager, cellular (cell) phone, mobile phone, smart phone, android phone, tablet phone, camera phone, iphone, ipad, blackberry, netbook, or combinations of any of the preceding.

The RF signal-detector can comprise: a RFID reader, RFID reader and writer, RFID module, RF printed circuit board (PCB), RFID universal serial bus (USB) reader, RFID USB card reader, RFID sensor, RFID detector, external RFID signal-detector, internal RFID signal-detector located inside the CPU, RF transceiver, or combinations of any of the preceding;

The CPU can comprise: a computer, laptop, desktop computer, portable computer, mobile computer, workstation computer, microprocessor, computer system, computer network, network, tablet computer, wireless computer, wired computer; netbook, electronic communications device, portable networking device, internet communications device, radiotelephone, cellular (cell) phone, mobile phone, smart phone, flip phone, slider phone, qwerty phone, android phone, iphone, tablet phone, camera phone, clamshell device, portable networking device, wireless device, mobile communications device, personal digital assistant (PDA), wireless e-mail device, two way pager, internet communication device, android tablet, ipod, ipad, blackberry, tablet device, computer, netbook, wireless device, bluetooth compatible device, headphone-compatible device, cell phone-compatible device, android phone-compatible device, electronic pairing device, electronic data sharing device, or combinations of any of the preceding.

The display can comprise: a monitor, display screen, touch screen, touchpad, ipad, or combinations of any of the preceding;

The inputting device can comprise: a touch screen, touch pad, screen pad, keypad, keyboard, wireless keyboard, keys, buttons, electronic mouse, wireless mouse, audible input device, bluetooth device, verbal input device, microphone, wireless headset with microphone, transmitter or combinations of any of the preceding.

Besides a physician, the medical personnel can include a dentist, podiatrist, veterinarian, a practitioner registered with the U.S. Drug Enforcement Administration (DEA), U.S. public health official, nurse practitioner, certified nurse-midwife, certified registered nurse anesthetist, clinical nurse specialist, oriental medicine doctor, euthanasia technician, medical psychologist, physician assistant, clinician, or combinations of any of the preceding.

The RFID codes comprising the RFID signal can be inputted and based upon one or more of the following indicia of the authorized user: blood type, fingerprint, DNA information, face, eyes, race, nationality, name, birthdate, address, social security number, passport number, personal identification number (PIN), passport information, driver's license, identification card information, encrypted personal information, scrambled personal information, pixilated information, skin texture, dental information, facial information, computerized personal information, embedded personal information, algorithm based personal information, software supported personal information, biological information, electronic voice, electronic speech, audio information, and visual information (identification) of the user.

The information inputted into the EMR about the patient can comprise one or more of the following: patient conditions, patient temperature, patient blood pressure, patient allergies, patient medical history, patient treatment, patient prognosis, patient diagnosis, patient allergies, patient medical injections, and patient shots, and patient prescribed medicine.

In the illustrative process and system, radio-frequency identification (RFID) can provide the use of a wireless non-contact process and system that uses radio-frequency (RF) electromagnetic fields to transfer data from a RFID communications device for the purposes of automatic identification, access and retrieval of patient EMRs. Some RFID communications devices require no battery and are powered by the electromagnetic fields used to read them. Other RFID communications device can use a local power source and emit radio waves comprising electromagnetic radiation at radio frequencies. The RFID communications devices contain electronically stored information about the identity and physical attributes of the physical or other medical personnel which can be read from up to several meters (yards) away. Unlike a bar code, the RFID communications device does not need to be within line of sight of the reader and may be embedded in the tracked object. The RFID communications device can comprise a RFID chip or microchip that contains a RF electromagnetic field coil that modulates an external magnetic field to transfer a coded identification number (RFID code) when queried, sensed and detected by a RFID reader or other RF signal-detector. RFID communications devices can be attached to clothing, possessions, hair, or even less desirably implanted within people.

RFID offers advantages over manual systems or use of bar codes. RFID communications devices can be read if passed near a RFID reader or other RF signal-detector, even if it is covered by the object or not visible. The RFID communications device can be read inside a pocket, purse, or wallet. In contrast to barcodes, RFID communications devices can be read hundreds at a time while bar codes can only be read one at a time.

The RFID EMR process and system can use RFID cards, badges, tags, and other RFID communications devices to be identified. Two-way radio transmitter-receivers or other RF signal-detectors which are sometime referred to as interrogators or readers can send and/or receive a signal from the RFID communications device and read its response. The readers generally transmit their observations to a CPU running RFID software, RFID middleware or RFID firmware.

RFID information in the RFID communications device can be stored electronically in a non-volatile memory. The RFID communications device can include a small RF transmitter and receiver. A RFID reader or other RF signal-detector can transmit and/or receive an encoded RF signal such as an RFID code to interrogate the RFID communications device. The RFID communications device can receive the RFID signal and respond with its electronic authorization and approval signed if the user (physician) is electronically listed in the data base of authorized users.

RFID communications devices can be either passive, active or battery assisted passive. An active RFID communications device has an on-board battery that periodically transmits its ID signal. A battery assisted passive (BAP) RFID communications device has a small battery on board that is activated when in the presence of a RFID reader or other RF signal-detector. A passive RFID communications device is less expensive and smaller because it has no battery. Instead, the passive RFID communications device uses RF energy transmitted by the RFID reader or other RF signal-detector as its energy source. The RF signal-detector should be close for RF field to be strong enough to transfer sufficient power to the passive RFID communications device. Since RFID communications devices have individual RF codes and RFID signals, the RF signal-detector can distinguish among several RFID communications devices that might be within the range of the RF signal-detector and read them simultaneously. RFID communications devices can be either read-only or read/write, where specific ID information and data can be written into the RFID communications device by an authorized user. Mobile computers, with integrated RFID readers, help minimize or eliminate paperwork, give proof of identification and access and provide greater security.

RFID communications device can contain at least two parts: an integrated circuit (IC) for storing and processing information, modulating and demodulating a radio-frequency (RF) signal, collecting DC power from the RFID signal, as well as an antenna for receiving and transmitting the RFID signal.

Fixed readers or stationary RF signal-detectors can be set up to create a specific interrogation zone which can be tightly controlled. This allows a highly defined reading area for when RFID communications devices enter and exit the interrogation zone. Mobile readers and portable RF signal-detectors can be hand-held or mounted on medical carts and moveable equipment for use in medical facilities.

High-frequency RFID communications device are much more useful than earlier magnetic stripe cards. RFID badges need only be held within a certain distance of the reader to authenticate the user. RFID tags can have: low cost, high volume manufacturing minimal implementation investment is disposable or one-time use and a read range optimized increase speed and utility.

RFID communications device which comprise a RFID chip can store a static RFID code and can have an antenna that enables the chip to transmit the stored number to a RFID reader or other RF signal-detector. When the RFID communications device comes within range of the appropriate RFID reader, the RFID communications device is powered by the reader's RF field and transmits its RFID to the RFID reader. RFID communications device can be easily read from distances of several inches (centimeters) to several yards (meters).

RFID contactless smart cards can be used to protect personal information or deliver secure confidential information. Contactless smart cards can have a RF interface that allows RFID contactless smart cards to be read at a short distance from the RF signal-detector. The RFID contactless device can include a smart card secure microcontroller or equivalent intelligence, internal memory and has the ability to securely manage, store and provide access to data on the card, perform complex functions, such as encryption or other security functions, and interact intelligently via RF with a contactless reader or other RF signal-detector. RFID contactless smart cards can provide many security features that ensure the integrity, confidentiality and privacy of information stored or transmitted. RFID contactless smart card-based devices can verify that the RFID reader is authentic and can prove its own authenticity to the RFID reader before authorizing access to the EMRs. RFID contactless smart cards can be difficult to duplicate or forge and can be tamper-resistant. RFID contactless smart cards can verify the authority and identification of the user (requestor) and then allow access only to the information required on a need to know basis. Access to stored information can also be further protected by a RFID code, electronic personal identification number (PIN), and/or electronic biometric information to protect privacy and assure unauthorized access. RFID contactless smart cards can strengthen the ability of the RFID EMR process and system to protect the individual privacy and confidentiality of patient EMRs. RFID smart cards based can also implement a personal firewall for a patient and physician, releasing only the information required and only when it is required. RFID contactless smart cards can help protect confidential personal information of EMRs and ensure that communication with the contactless device is secure. RFID chips and RFID smart cards can help the RFID EMR process and system to comply with privacy and security guidelines, as well as provide the speed and convenience of contactless communication.

Among the many advantages of the RFID EMR process and system are:
1. Superior method and system to access, creating and modify EMRs.
2. Outstanding process and system to generate transmit and print electronically signed prescriptions, medical notes (progress reports) and other EMRs.
3. Excellent compliance with the two factor authentication required by the U.S. Drug Enforcement Administration (DEA) of the U.S. Department of Justice.
4. Superb performance.
5. Better security.
6. User friendly.
7. Reliable.
8. Convenient.
9. Easy to use.
10. Dependable.
11. Economical.
12. Effective.

Although embodiments of the invention have been shown and described, it is to be understood that various modifications, substitutions, and rearrangements of parts, components, equipment and/or process (method) steps, as well as other uses of the RFID EMR process and system can be made by those skilled in the art without departing from the novel spirit and scope of this invention.

What is claimed is:

1. A process, comprising the steps of:
transmitting a user identification (ID) signal corresponding to a physician or other medical personnel;
detecting said user ID signal;
electronically comparing said user ID signal with indicia of authorized users to determine if the physician or other medical personnel is an authorized user; and
authorizing access to each electronic medical records (EMR) of patients of the medical personal if the medical personnel is an authorized user.

2. A process in accordance with claim 1 including:
inputting information into said EMR; and
said authorizing access including allowing said authorized user to input information into said EMR.

3. A process in accordance with claim 1 including:
generating a new EMR; and
said authorizing access including allowing said authorized user to generate said new EMR.

4. A process in accordance with claim 1 including:
viewing said EMR; and
said authorizing access including allowing said authorized user to view said EMR.

5. A process in accordance with claim 1 including:
generating an electronic signature of said authorized user on said EMR; and
said authorizing access including allowing said electronic signature to be generated.

6. A process in accordance with claim 1 including:
transmitting said EMR to a designation selected by said authorized user; and
said authorizing access including allowing said authorized user to select a designation for receiving the transmitted EMR.

7. A process in accordance with claim 1 including:
inputting an electronic prescription into said EMR;
generating an electronic signature authorized by said authorized user onto said electronic prescription; and
said authorizing access including allowing said authorized user to input said electronic prescription into said EMR.

8. A process in accordance with claim 1 including:
inputting physician's notes about a patient into said EMR;
generating an electronic signature authorized by said authorized user onto said physician's notes; and
said authorizing access including allowing said authorized user to input said physician's notes into said EMR.

9. A process in accordance with claim 1 including:
printing said EMR;
said authorizing access including allowing said authorized user to print said EMR.

10. A process in accordance with claim 1 wherein:
said user ID signal is a radio frequency (RF) signal;
said user ID signal is transmitted from a user ID communications device;
said user ID signal is detected by a RF reader;
said electronic comparing occurs in a central processing unit (CPU);
said EMR is accessible in said CPU;
said EMR is viewable on a display of said CPU; and
said medical personnel is selected from the group consisting of: a dentist, podiatrist, veterinarian, a practitioner registered with the U.S. Drug Enforcement Administration (DEA), U.S. public health official, nurse practitioner, certified nurse-midwife, certified registered nurse anesthetist, clinical nurse specialist, oriental medicine doctor, euthanasia technician, medical psychologist, physician assistant, clinician and combinations of any of the preceding.

11. A process, comprising the steps of:
providing a radio frequency user identification (RFID) communications device to an authorized physician or other authorized medical personnel;
transmitting a RFID signal from said RFID communications device;
sensing and detecting said RFID signal with a radio frequency (RF) signal-detector operatively connected to a central processing unit (CPU);
electronically storing at least one electronic medical record (EMR) in said CPU;
determining if said authorized physician or other authorized medical personal is authorized to access said EMR in said CPU by electronically comparing said user ID signal with indicia of an authorized user in said CPU;
authorizing access to each EMR of patients of said authorized physician or other authorized medical personal in said CPU if said authorized physician or other authorized medical personnel is an authorized user, said authorizing access including allowing said authorized user to view said EMR on a display operatively connected to said CPU, allowing said authorized user to retrieve said EMR in said CPU, and allowing said authorized user to input information into said EMR with an inputting device operatively connected to said CPU;
electronically writing, transmitting and storing an electronic signature of said authorized user in said CPU;
inputting and electronically writing an electronic prescription for medication for at least one patient into said EMR in said CPU by said authorized user with said inputting device; and
generating said electronic signature of said authorized user comprising said authorized physician or other authorized medical personnel on said electronic prescription.

12. A process in accordance with claim 11 including:
transmitting said electronic prescription with said electronic signature to a pharmaceutical designation selected by said authorized user; and
said authorizing access including allowing said authorized user to select a pharmaceutical designation for receiving the transmitted electronic prescription.

13. A process in accordance with claim 11 including:
printing said electronic prescription with said electronic signature with a printer;
said authorizing access including allowing said authorized user to print said prescription.

14. A process in accordance with claim 11 including:
determining if said physician or medical personnel is authorized to write said prescription at a location where said prescription is being electronically written or filled by electronically comparing said user ID signal with an electronic file, electronic list or data base of persons authorized to write prescriptions at said location, said electronic file, list or data base being accessible in said CPU;
said access to said EMR in said CPU being denied and inaccessible after a preselected period of time when no RFID signal from said RFID communications device is sensed and detected by said RF signal-detector; and
said CPU being locked and inaccessible until said user logs in by inputting an authorized user password into said CPU with said inputting device.

15. A process in accordance with claim 11 wherein
said medical personnel is selected from the group consisting of: a dentist, podiatrist, veterinarian, a practitioner registered with the U.S. Drug Enforcement Administration (DEA), U.S. public health official, nurse practitioner, certified nurse-midwife, certified registered nurse anesthetist, clinical nurse specialist, oriental medicine doctor, euthanasia technician, medical psychologist, physician assistant, clinician, and combinations of any of the preceding;
said indicia of said authorized user being selected form the group consisting of: blood type, fingerprint, DNA information, face, eyes, race, nationality, name, birthdate, address, social security number, passport number, personal identification number (PIN), passport information, driver's license, identification card information, encrypted personal information, scrambled personal information, pixilated information, skin texture, dental information, facial information, computerized personal information, embedded personal information, algorithm based personal information, software supported personal information, biological information, electronic voice, electronic speech, audio information, visual information, and combinations of any of the preceding;
said information inputted into said EMR including patient information selected from the group consisting of: patient conditions, patient temperature, patient blood pressure, patient allergies, patient medical history, patient treatment, patient prognosis, patient diagnosis, patient allergies, patient medical injections, patient shots, patient prescribed medicine, and combinations of the preceding;
said RFID communications device is selected from the group consisting of: a RFID card, RF emitting powered card, RFID tag, RFID badge, RFID label, RFID transducer, RFID chip, RFID microchip, active RFID communications device, passive RFID communications device, battery assisted passive RFID communications device, implanted RFID communications device, RF-enabled smart card, RF-enabled contactless smart card, and combinations of any of the preceding;
said RFID communications device is carried by a RFID carrier selected from the group consisting of: RFID card protector, a clip, wallet, purse, envelope, sleeve, pocket, wrist band, bracelet, neck band, necklace, ankle band, ankle bracelet, belt, medical gown, lab coat, portable electronic communications device, pager, cellular (cell) phone, mobile phone, smart phone, android phone, tablet phone, camera phone, iphone, ipad, blackberry, netbook, and combinations of any of the preceding;
said RF signal-detector is selected from the group consisting of: a RFID reader, RFID reader and writer, RFID module, RF printed circuit board (PCB), RFID universal serial bus (USB) reader, RFID USB card reader, RFID sensor, RFID detector, external RFID signal-detector, internal RFID signal-detector located inside said CPU, RF transceiver, and combinations of any of the preceding;
said CPU is selected from the group consisting of: a computer, laptop, desktop computer, portable computer, mobile computer, workstation computer, microprocessor, computer system, computer network, network, tablet computer, wireless computer, wired computer; netbook, electronic communications device, portable networking device, internet communications device, radiotelephone, cellular (cell) phone, mobile phone, smart phone, flip phone, slider phone, qwerty phone, android phone, iphone, tablet phone, camera phone, clamshell device, portable networking device, wireless device, mobile communications device, personal digital assistant (PDA), wireless e-mail device, two way pager, internet communication device, android tablet, ipod, ipad, blackberry, tablet device, computer, netbook, wireless device, bluetooth compatible device, headphone-compatible device, cell phone-compatible device, android phone-compatible device, electronic pairing device, electronic data sharing device, and combinations of any of the preceding.
said display is selected from the group consisting of: a monitor, display screen, touch screen, touchpad, ipad, and combinations of any of the preceding;
said inputting device is selected from the group consisting of: a touch screen, touch pad, screen pad, keypad, keyboard, wireless keyboard, keys, buttons, electronic mouse, wireless mouse, audible input device, bluetooth device, verbal input device, microphone, wireless headset with microphone, transmitter and combinations of any of the preceding; and
said pharmaceutical destination is selected from the group consisting of: a pharmacy, drug store, pharmaceutical department of a hospital, checkout station in a physician's office, nurse's station in a hospital, a checkout stations in a medical facility, and a pharmacist.

16. A process, comprising the steps of:
providing a radio frequency user identification (RFID) communications device to an authorized physician or other authorized medical personnel;
transmitting a RFID signal from said RFID communications device;
sensing and detecting said RFID signal with a radio frequency signal-detector operatively connected to a central processing unit (CPU);
storing at least one electronic medical record (EMR) of patients in said CPU;
determining if said an authorized physician or other authorized medical personal is authorized to access said EMR in said CPU by electronically comparing said user ID signal with indicia of an authorized user in said CPU;
authorizing access to each EMR of patients of said authorized physician or other authorized medical personal in said CPU if said authorized physician or other authorized medical personnel is an authorized user, said authorizing access including allowing said authorized user to view said EMR on a display operatively connected to said CPU, allowing said authorized user to retrieve said EMR in said CPU, and allowing said authorized user to electronically input information into said EMR with an inputting device operatively connected to said CPU;
electronically writing, transmitting and storing an electronic signature of said authorized user in said CPU;
electronically writing and inputting notes of said authorized physician or other authorized medical personnel comprising said authorized user into said CPU to create electronic medical notes by electronically inputting information about at least one of said patients into said EMR in said CPU with said inputting device; and
generating said electronic signature of said authorized user on said electronic medical notes of said EMR in said CPU.

17. A process in accordance with claim 16 including:
transmitting said electronic medical notes with said electronic signature to a designation selected by said authorized user; and
said authorizing access including allowing said authorized user to select a designation for receiving the transmitted electronic medical notes.

18. A process in accordance with claim 16 including:
printing said electronic medical notes with said electronic signature with a printer;
said authorizing access including allowing said authorized user to print said electronic medical notes.

19. A process in accordance with claim 16 including:
said access to said EMR in said CPU being denied and inaccessible after a preselected grace period of time when no RFID signal from said RFID communications device is sensed and detected by said RF signal-detector; and
said CPU being locked and inaccessible until said user logs in by inputting an authorized user password into said CPU with said inputting device.

20. A process in accordance with claim 16 wherein
said medical personnel is selected from the group consisting of: a dentist, podiatrist, veterinarian, a practitioner registered with the U.S. Drug Enforcement Administration (DEA), U.S. public health official, nurse practitioner, certified nurse-midwife, certified registered nurse anesthetist, clinical nurse specialist, oriental medicine doctor, euthanasia technician, medical psychologist, physician assistant, clinician, and combinations of any of the preceding;
said indicia of said authorized user being selected form the group consisting of: blood type, fingerprint, DNA information, face, eyes, race, nationality, name, birthdate, address, social security number, passport number, personal identification number (PIN), passport information, driver's license, identification card information, encrypted personal information, scrambled personal information, pixilated information, skin texture, dental information, facial information, computerized personal information, embedded personal information, algorithm based personal information, software supported personal information, biological information, electronic voice, electronic speech, audio information, visual information, and combinations of any of the preceding;
said information inputted into said EMR including patient information selected from the group consisting of: patient conditions, patient temperature, patient blood pressure, patient allergies, patient medical history, patient treatment, patient prognosis, patient diagnosis, patient allergies, patient medical injections, patient shots, patient prescribed medicine, and combinations of the preceding;
said RFID communications device is selected from the group consisting of: a RFID card, RF emitting powered card, RFID tag, RFID badge, RFID label, RFID transducer, RFID chip, RFID microchip, active RFID communications device, passive RFID communications device, battery assisted passive RFID communications device, implanted RFID communications device, RF-enabled smart card, RF-enabled contactless smart card, and combinations of any of the preceding;
said RFID communications device is carried by a RFID carrier selected from the group consisting of: a RFID card protector, clip, wallet, purse, envelope, sleeve, pocket, wrist band, bracelet, neck band, necklace, ankle band, ankle bracelet, belt, medical gown, lab coat, portable electronic communications device, pager, cellular (cell) phone, mobile phone, smart phone, android phone, tablet phone, camera phone, iphone, ipad, blackberry, netbook, and combinations of any of the preceding;
said RF signal-detector is selected from the group consisting of: a RFID reader, RFID reader and writer, RFID module, RF printed circuit board (PCB), RFID universal serial bus (USB) reader, RFID USB card reader, RFID sensor, RFID detector, external RFID signal-detector, internal RFID signal-detector located inside said CPU, RF transceiver, and combinations of any of the preceding;
said CPU is selected from the group consisting of: a computer, laptop, desktop computer, portable computer, mobile computer, workstation computer, microprocessor, computer system, computer network, network, tablet computer, wireless computer, wired computer; netbook, electronic communications device, portable networking device, internet communications device, radiotelephone, cellular (cell) phone, mobile phone, smart phone, flip phone, slider phone, qwerty phone, android phone, iphone, tablet phone, camera phone, clamshell device, portable networking device, wireless device, mobile communications device, personal digital assistant (PDA), wireless e-mail device, two way pager, internet communication device, android tablet, ipod, ipad, blackberry, tablet device, computer, netbook, wireless device, bluetooth compatible device, headphone-compatible device, cell phone-compatible device, android phone-compatible device, electronic pairing device, electronic data sharing device, and combinations of any of the preceding.
said display is selected from the group consisting of: a monitor, display screen, touch screen, touchpad, ipad, and combinations of any of the preceding; and
said inputting device is selected from the group consisting of: a touch screen, touch pad, screen pad, keypad, keyboard, wireless keyboard, keys, buttons, electronic mouse, wireless mouse, audible input device, bluetooth device, verbal input device, microphone, wireless headset with microphone, transmitter and combinations of any of the preceding.
